(19) United States
(12) Patent Application Publication
(10) Pub. No.: US 2005/0035877 A1
(43) Pub. Date: Feb. 17, 2005

(54) Automatic meter reading system and method for transmitting meter reading data in the same

(76) Inventor: Duk-Soo Kim, Bucheon-si (KR)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/637,395

(22) Filed: Aug. 11, 2003

(51) Int. Cl. G08B 23/00

(52) U.S. Cl. 340/870.02; 382/100

(57) ABSTRACT

Disclosed is a remote automatic meter reading (AMR) system for image-sensing, reading and transmitting metering values. The AMR system includes an AMR terminal, a collector and an AMR server. The AMR terminal includes an image sensing module for sensing an image signal of a metering value displayed on a display panel of the meter. A character recognition module performs pattern recognition of the image signal, and a communication module transmits digital data from the character recognition module to the AMR server side. The character recognition module may include a microcomputer and an ID setting During power saving mode, the microcomputer wakes up and decodes received data; and when a meter reading command is received, the image sensing module receives the image signal of the metering value, performs pattern recognition, generates the numeral code to form a packet together with the terminal ID, and transmits the packet to the communication module.

### BACKGROUND OF THE INVENTION

1. Field of the Invention

The present invention relates to an automatic meter reading system capable of performing remote meter reading with respect to various kinds of meters, and more particularly to a remote automatic meter reading system capable of image-sensing, reading and transmitting metered values of various meters.

2. Description of the Prior Art

With the development of scientific technology, it is a general phenomenon that human tasks are automatically carried out by a machine. Conceptually, the term of “remote meter reading” includes automatic meter reading (AMR) technology for automatically metering usage of water, electric power, gas and so forth which are used at each house, office or the like without a meter reader. Typically, the AMR comprises an AMR terminal installed at each house, office or the like, an AMR server for controlling the meter reading, performing charging according to a meter reading value, and performing customer management at the central center, and a communication means for transmitting the meter reading value of the AMR terminal to the AMR server.

However, the conventional remote AMR system must carry out modification or alteration of the meter in order to automatically perform meter reading of metered values on the meter. As a result, there is a problem in that it is necessary to spend huge cost caused by the structural change. Further, there is another problem in that image data sensing the metered values are transmitted without any change, and thus communication cost is increased due to a good deal of transmission data.

### SUMMARY OF THE INVENTION

The present invention has been made to solve the foregoing problems and it is therefore an object of the present invention to provide a remote automatic meter reading (AMR) system capable of automatically performing meter reading only by attaching it to an existing meter without changing the existing meter.

It is another object of the present invention to provide a remote AMR system capable of being employed to all kinds of meters, such as a water meter, a gas meter, an electric power meter and so forth in order to enable integrated meter reading to be performed.

It is yet another object of the present invention to reduce an amount of data which is necessary to perform communication by sensing metered values of an existing meter as an image, reading the metered value through a pattern recognition technology, and transmitting the read value in a form of a code.

It is yet another object of the present invention to provide a remote AMR system capable of minimizing maintenance cost caused by battery change by minimizing electric power spent from a terminal.

It is still yet another object of the present invention to, using a collector, reduce loads of a meter reading server, which arise on communicating from a meter reading terminal to the meter reading server, costs and communication time to read the metered value.

To accomplish the above objects, the present invention provides an automatic meter reading (AMR) system comprising: at least one AMR terminal, attached to the corresponding meter, for transmitting meter reading data; and an AMR server for commanding the AMR terminal to perform meter reading and for processing meter reading data transmitted from the AMR terminal to perform charging, the AMR terminal comprising: an image sensing module for sensing an image signal of a metering value displayed on a numeral display panel of the meter; a character recognition module for performing pattern recognition of the image signal transmitted from the image sensing module and for generating a numeral code of the metering value to output it in a predetermined format, the character recognition module comprising a microcomputer and an ID setting means for setting a terminal ID; and a communication module for transmitting digital data transmitted from the character recognition module to the AMR server side, wherein: when a communication signal is received from the AMR server during operation of a power saving mode, the microcomputer wakes up and decodes received data; and when a meter reading command is received, the microcomputer operates the image sensing module to receive the image signal of the metering value, performs pattern recognition according to a predetermined algorithm, generates the numeral code of the metering value to form a packet together with the terminal ID, and transmits the packet to the communication module.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating the overall construction of a remote automatic meter reading (AMR) system according to a first embodiment of the present invention;

FIG. 2 is a flow chart showing an operational procedure of a remote AMR system according to a first embodiment of the present invention;

FIG. 3 shows a first embodiment of the AMR terminal of FIG. 1;

FIG. 4 is a timing view for illustrating an operation mode of a remote AMR terminal according to the present invention;

FIG. 5 is a flow chart showing operation of a remote AMR terminal according to the present invention;

FIG. 6 shows a second embodiment of the AMR terminal of FIG. 1;

FIG. 7 is a schematic view showing a third embodiment of the AMR terminal of FIG. 1 and a situation in which a modem chip is used;

FIG. 8 is a schematic view showing a situation in which an external modem is used in the third embodiment of the AMR terminal shown in FIG. 7;

FIG. 9 is a block diagram showing construction of a collector according to the present invention;

FIG. 10 is a flow diagram showing all procedures of the AMR according to the present invention;

FIG. 11 is a flow diagram showing a procedure of individual AMR according to the present invention;

FIG. 12 illustrates a first interface between a collector and an AMR terminal according to the present invention;

FIG. 13 illustrates a second interface between a collector and an AMR terminal according to the present invention;

FIG. 14 illustrates a first interface between a collector and an AMR server according to the present invention;

FIG. 15 illustrates a second interface between a collector and an AMR server according to the present invention;

FIG. 16 illustrates a third interface between a collector and an AMR server according to the present invention;

FIG. 17 illustrates a fourth interface between a collector and an AMR server according to the present invention;

FIG. 18 shows a remote AMR system according to a second embodiment of the present invention;

FIG. 19 shows a first embodiment of the AMR terminal of FIG. 18; and

FIG. 20 shows a second embodiment of the AMR terminal of FIG. 18.

### DESCRIPTION OF THE PREFERRED EMBODIMENTS

A preferred embodiment of the invention will be described below in detail with reference to the accompanying drawings.

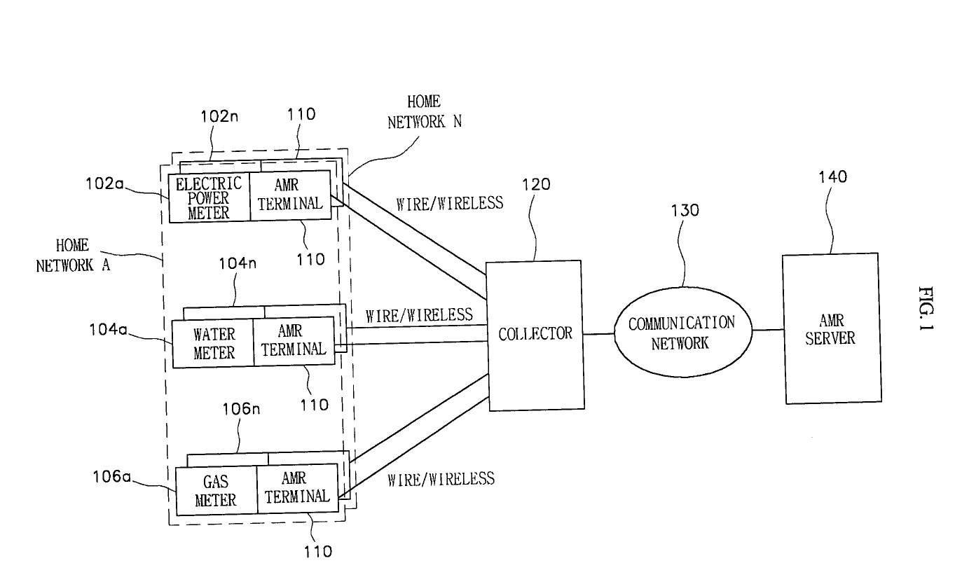

FIG. 1 is a schematic view illustrating the overall construction of a remote automatic meter reading (AMR) system according to a first embodiment of the present invention.

As shown in FIG. 1, the remote automatic meter reading system according to the present invention comprises a plurality of automatic meter reading (AMR) terminals 110, each of which is attached to various types of meters 102a to 102n, 104a to 104n, and 106a to 106n, within each residential building, a collector 120 for allowing metered values of the plurality of AMR terminals 110 to be collected and transmitted to an AMR server 140 through a communication network 130, and the AMR server 140.

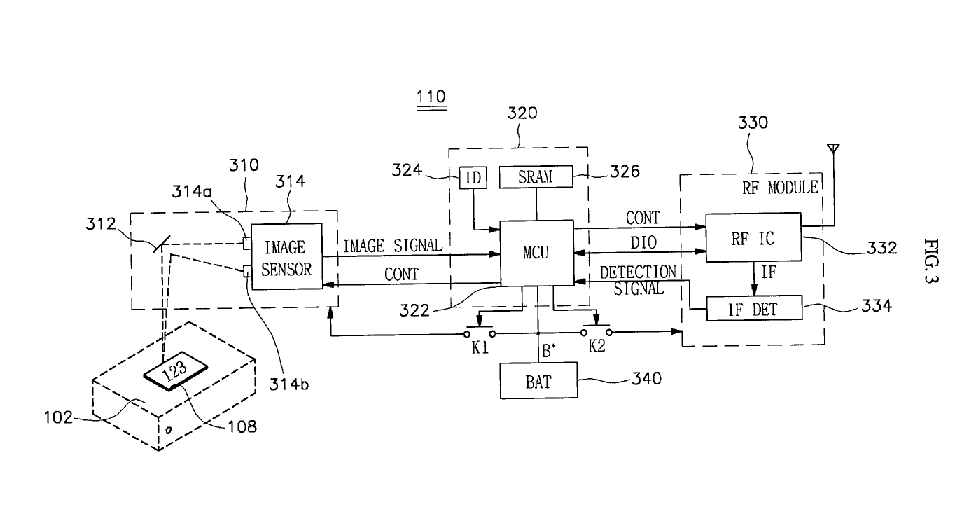

Referring to FIG. 1, electric power meters 102a to 102n, water meters 104a to 104n and gas meters 106a to 106n are those installed at each residential building, for example, at each house. Each of these meters is provided with a numerical display panel 108 (see FIG. 3) for indicating a metered value, and thus the metered value of the numerical display panel is read by a meter reader (referred to as a “manual meter reading”). Therefore, charging can be carried out depending on the metered value or usage.

Each of the AMR terminals 110 is attached to an existing meter and is designed so that the metered value of the numerical display panel is picked up as an image, the metered value is read according to a pattern recognition (or character recognition) technology, and the read data (for instance, an ASCII code for the metered numeral) are transmitted to the collector 120. This AMR terminal 110 may include at least one of a sensor module, a character recognition module, a communication module and the like, as will be mentioned below. The AMR terminal is classified into a “wire communication mode” and a “wireless communication mode” according to the mode of performing communication between the communication module and the collector 120, and more particular, in the case of the wireless communication mode, the AMR terminal is re-classified into an “integrated type” in which the communication module is integrally installed with the sensor module and the character recognition module, and into a “separated type” in which the communication module is discretely installed from the sensor module and the character recognition module.

The collector 120 requires a great many communication lines when each AMR terminal 110 communicates directly with the AMR server 140 in a one-to-one mode, thus generating a problem in that communication cost is increased. To solve this problem, the collector 120 is installed within every predetermined area, collects the metered values transmitted from all AMR terminals 110 within a controllable area, and transmits the collected resultants to the AMR server 140 through the communication network 130. This collector 120 may be complemented in diverse ways, according to the mode of communicating with the AMR terminals 110 and the mode of communication with the AMR server 140 (i.e., what kinds of communication networks are employed). For instance, with the AMR terminals 110, communication may be performed in a wire or wireless (or satellite or citizen band) mode. With the AMR server 140, communication may be performed through a Public Switched Telephone Network (PSTN), Internet, a personal radio network (cellular communication network), a satellite communication network, an electric power line network, a cable network, an optical cable network and so forth.

The AMR server 140 administers information on customers who have at least two types of meters, and processes charging based on a usage of each customer by reading the metered value of each AMR terminal 110 through the collector 120 at every predetermined period. This AMR server 140 is implemented as a plurality of computer systems having built-in application programs for AMR. If necessary, the AMR server 140 may be classified into local servers distributed locally, a central server incorporated with the local servers and so forth, so that it can be hierarchically constructed. It is preferred that the application programs operated by the AMR server 140 have various functions, such as a maintenance function capable of checking conditions of the collector 120, a warning function for warning when a failure is generated, an command function for commanding a manual meter reading, a statistical processing function for statistically processing metered values according to each customer, a reporting function for generating various reports and so forth. Further, the AMR server 140 needs substantially a collector ID, a terminal ID and a customer information table related to the corresponding customer as shown below in Table 1.

TABLE 1

| Customer information | | | | | | |
|---|---|---|---|---|---|---|
| | Personal ID | | | | | |
| Name | number | Address | Phone | Collector ID | Terminal ID | Type of meter |
| David | *****-***** | xxxx | 239-0021 | 245-327 | 326-715 | Electric power |
| Daniel | *****-***** | yyyy | 554-9001 | 235-327 | 327-918 | Water |
| ˜ | ˜ | ˜ | ˜ | ˜ | ˜ | ˜ |

As shown in Table 1, the AMR server 140 puts the collector ID, the terminal ID and the type of meter together with the customer information into a database and administers the database.

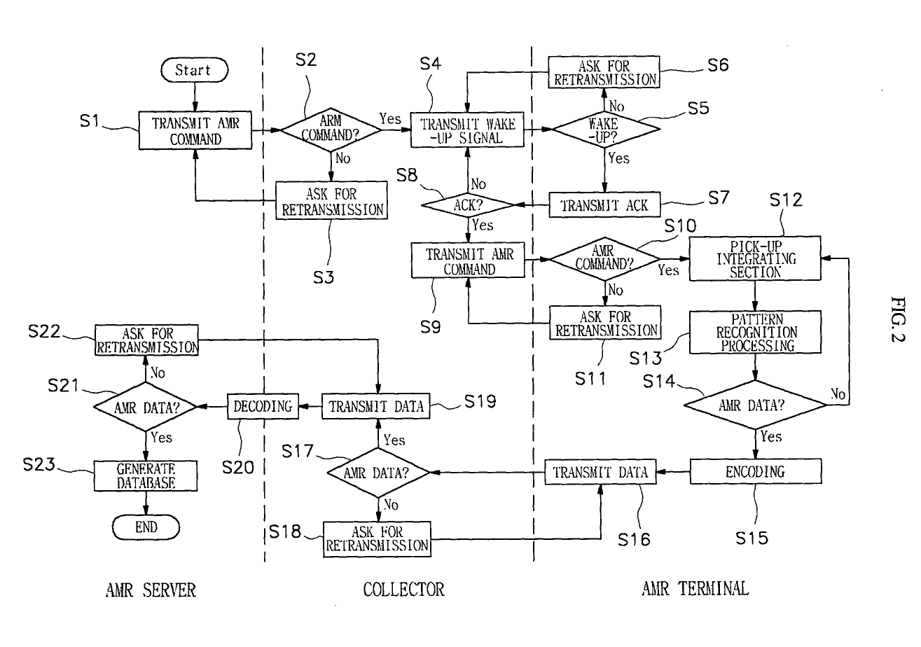

FIG. 2 is a flow chart showing an operational procedure of a remote AMR system according to a first embodiment of the present invention.

AMR is carried out by an organic operation between the AMR terminals 110, which are installed at each residential building such as a house, a business building or the like, the collector 120 which is installed at a predetermined place, and the AMR server 140 which performs the AMR application programs.

Firstly, when a due period for the AMR arrives and the AMR needs to be performed, the AMR server 140 transmits an AMR command to the corresponding collector 120 (S1). The AMR command is transmitted to the collector 120 through a PSTN, a mobile phone network, Internet and so forth, according to the communication mode employed. In this case, the AMR is classified into an “overall AMR” and an “individual AMR”, in which the overall AMR is simultaneously performed through all AMR terminals 110 under the control of the corresponding collector 120, while the individual AMR is performed through a designated particular AMR terminal 110. Therefore, the AMR command preferably includes such AMR modes, information on the AMR terminal to which the AMR is performed, and so forth.

When the collector 120 receives the AMR command, it checks whether or not the AMR command is transmitted normally without any error. If the AMR command is transmitted normally, the collector 120 transmits an acknowledge (ACK) signal. However, if the AMR command is transmitted abnormally, the collector 120 asks for retransmission (S2, S3). To be more specific, if transmission of the AMR command is normal, the collector 120 decodes the AMR command and generates it as decoded and generates a wake-up signal for activating the corresponding AMR terminal 110 according to an AMR mode (S4). The wake-up signal is transmitted to the AMR terminal 110 by wire or by wireless according to a communication mode between the collector 120 and the AMR terminal 110.

When the AMR terminal 110 receives the wake-up signal from the collector 120 while operating in a power-saving mode, the AMR terminal 110 decodes the received data. If the received data is normal, the AMR terminal 110 transmits an ACK signal to the collector 120. However, if the received data is abnormal, the AMR terminal 110 asks for retransmission (S5 to S7).

When the collector 120 receives the ACK signal from the AMR terminal 110, the collector 120 transmits the AMR command (S8, S9). Subsequently, if the AMR terminal 110 receives the AMR command, the AMR terminal 110 performs image sensing with respect to the numeral display panel of the meter by means of the sensor module, as will be mentioned below, and reads the metered value by processing image data by means of pattern recognition technology. Then, if the metered value is read normally, the AMR terminal 110 encodes the metered value in a predetermined format, and then transmits the resultant to the collector 120 (S10 to S16). However, if the metered value is read abnormally, the AMR terminal 110 performs the image sensing again, and then repeats such a reading procedure.

When the collector 120 receives the AMR data from each AMR terminal 110, the collector 120 checks whether the AMR data are abnormal or normal. If the AMR data are normal, the collector 120 stores the metered normal data in memory. However, if the AMR data are abnormal, the collector 120 asks for retransmission (S17, S18). Further, if all the AMR data are received from the corresponding AMR terminals 110, the collector 120 encapsulates all the AMR data in a predetermined format and then transmits the resultant to the AMR server 140 through the communication network 130.

The AMR server 140 decomposes the AMR data which are received from the collector 120. Here, if the AMR data is normal, the AMR server 140 stores the AMR data on the database. However, if the AMR data is abnormal, the AMR server 140 asks for retransmission (S20 to S23). The AMR data stored on the database are used to perform charging or statistical processing in the future.

Therefore, the AMR system according to the present invention has several advantages in that labor costs can be reduced because the AMR system is capable of performing automatic meter reading without any meter reader, in that the amount of data can be reduced because the AMR system reads image data and then transmits the read image data in a form of an ASCII code for the metered values, and in particular in that communication costs can be reduced because the AMR system relays communication between the AMR server and the AMR terminal using the collector.

Hereinafter, a detailed description will be made regarding the AMR terminal employed to the present invention, in which the AMR terminal is classified into a “wire communication mode” and a “wireless communication mode” according to a mode of communicating with the collector, and more particularly in the case of the wireless communication mode, the AMR terminal is classified into an “integrated type” in which the communication module is integrally installed with the sensor module and the character recognition module and a “separated type” in which the communication module is discretely installed from the sensor module and the character recognition module.

First Embodiment (The Integrated Type of the Wireless Communication Mode)

FIG. 3 shows a first embodiment of the AMR terminal 110 of FIG. 1. The AMR terminal 110 includes a sensor module 310, a character recognition module 320, a communication module 330, and a power source 340. The AMR terminal 110 communicates with the collector 120 in the wireless communication mode, and is the integrated type in which the communication module is integrally installed with the sensor module and the character recognition module. To be more specific, in the integrated type, the sensor module 310, the character recognition module 320 and the communication module 330 are integrally constructed and attached to a meter 102 by a mechanical means. The power source 340 may make use of a DC adaptor or the like in which a commercial power source is used, but it is preferred that the power source 340 makes use of a battery (BAT) for the sake of convenient installation. The BAT is designed to perform exchange with ease. To this end, the BAT is mounted on the AMR terminal 110 using a battery case.

Referring to FIG. 3, the sensor module 310 includes an optical mechanism for picking up a numeral image of a numeral display panel 108, and an image sensor 314 for converting a two dimensional image, which is picked up on a light receiving section 314b, into an electric signal. When the meter is installed in a dark place, for instance in the ground, as the water meter, it is preferred that the sensor module 310 includes a light source 314a generating light in order to perform image sensing. Here, light for performing image sensing can make use of light situated within the visible spectrum as well as light situated beyond the visible spectrum, such as ultraviolet radiation or infrared radiation, to be able to read numerals. When the numeral display panel is sensed using the image sensor 314, the optical mechanism, for example a reflecting mirror, is not required additionally. The optical mechanism can make use of various optical elements, such as a prism, a half mirror 312 and so forth.

The character recognition module 320 includes an MCU (Micro Controller Unit) 322 mounted therein with a flash memory, an EEPROM, an A/D port, input/output ports and so forth, an ID setting section 324 for setting terminal Ids, and an external memory 326. Here, an analog image signal inputted from the image sensor 314 is converted into a digital image signal. Subsequently, numerals displayed on the numeral display panel 108 are read according to a predetermined pattern recognition algorithm and are then converted into an ASCII code, and the resultant is stored and then transmitted to the communication module 330 according to a predetermined transmission format.

The communication module 330 includes an RF IC (Radio Frequency Integrated Circuit) 332 and an IF (Intermediate Frequency) detector 334, in which the RF IC 332 modulates digital data into RF signals, transmits the modulated RF signals to the collector 120, and then demodulates the received RF signals to regenerate the original digital data, and the IF detector 334 receives IF signals from the RF IC 332 and then detects whether or not the RF signals are present. When the RF signals are received from the collector 120, the IF detector 334 detects the RF signals and then informs the MCU 322 of the detected result. The RF IC 332 modulates digital data transmitted from the character recognition module 320 into the RF signals, and then transmits the modulated RF signals to the collector 120. The IF detector 334 is designed so that it detects whether or not the RF signals are received from the collector 120, and then informs the MCU 322 of the detected resultant. This function may be housed within the RF IC 332.

The AMR terminal 110 further comprises a current leakage detecting means, a battery low-voltage sensing means, and a terminal separation and breakage detecting means. Therefore, when an abnormal state, such as current leakage, battery low-voltage, terminal breakage, meter breakage or the like, is detected, the AMR terminal 110 is designated immediately so that it automatically informs the AMR server 140 of the abnormal state, and thus the operator is able to take measures to correct the situation. The AMR terminal 110 periodically performs meter reading after every predetermined period (for example, a quarter hour, one hour), and stores the AMR data. Then, when an AMR command is received from the AMR server 140, the AMR terminal 110 is capable of transmitting the stored data.

Further, the AMR terminals 110 are provided with a function for controlling the corresponding AMR terminal (or turning it on/off) according to a command signal of the AMR server 140, when a special situation, such as a fire, an earthquake, a typhoon or the like, occurs.

Meanwhile, the MCU 322 of the character recognition module 320 according to the present invention is housed together with a programmable flash memory, an EEPROM, an SRAM and so forth, and is a kind of microcomputer with various input/output ports. This MCU 322 is provided with a function for supporting a power saving mode in order to reduce consumption of electric power.

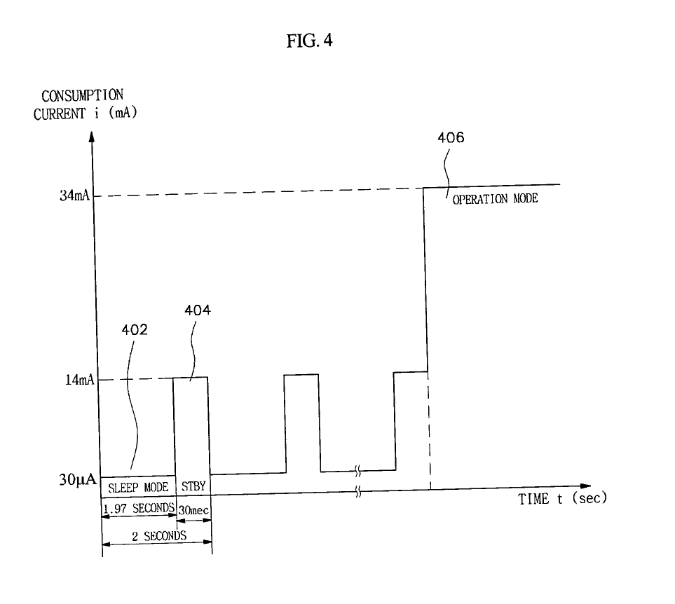

The AMR terminal 110 is usually operating in a power saving mode in order to minimize consumption electric power, as shown in FIG. 4. However, when a RF signal is detected from the collector 120, the AMR terminal 110 operates in a normal mode. Then, the AMR terminal 110 senses an image, reads a character, and then transmits AMR data to the AMR server 140. That is to say, the AMR terminal 110 of the present invention operates in any one mode from among a “sleep mode” in which consumption electric power is minimized, a “standby (STBY) mode” in which it is sensed whether or not RF signals are received from the collector 120, and a “normal mode” in which all the modules operate normally to read image-sensed data and then transmit AMR data. This operation is no more than one example, and it can be carried out in various modes.

Referring to FIG. 4, the transverse axis represents time t, and the longitudinal axis represents consumption current I. The case where the consumption current is minimum is the sleep mode 402. The case where the consumption current is in the middle range is the STBY mode 404. The case where the consumption current is maximum is the normal mode 406. Both the sleep mode 402 and the STBY mode 404 are power saving modes. At a usual time when AMR is not performed, the sleep mode 402 and the STBY mode 404 are alternated with each other at regular intervals (about 2 seconds). Then, when a reception signal is detected from the collector 120 in the STBY mode 404, the AMR terminal 110 operates in the normal mode 406. To be more specific, in the sleep mode 402, power applied either to the sensor module 310 or to the communication module 330 is blocked completely (by turning off relays K1 and K2) (see FIG. 3). While only the microcomputer 322 operates in a minimum electric power mode, sleep time is counted. Therefore, current consumed during the sleep mode 402 amounts to about 30 μA, and when the MCU 322 continues to count the sleep time during the sleep mode 402, but the sleep time reaches a predetermined setting time (1.97 seconds in the invention), the sleep mode 402 is converted into the STBY mode 404.

In the STBY mode 404, the relay K2 is turned on, and then power is supplied to the communication module 330, thus operating the communication module 330. As a result, the communication module 330 waits for reception of RF signals from the collector 120. After the MCU 322 operates in the STBY mode 404, the MCU 322 continues to count a STBY time. When the RF signals are not detected from the collector 120 within a predetermined time (30 ms in the invention), power applied to the communication module 330 is blocked. Then, the MCU 322 operates in the sleep mode again and counts the sleep time. In this manner, both the sleep mode and the STBY mode are usually alternated with each other with a predetermined period (e.g., 2 seconds in this case), and thus consumption of electric power can be minimized.

If the RF signals are received from the collector 120 in the STBY mode, the IF detector 334 detects the resultant and informs the MCU 322 of the detected resultant. Therefore, the MCU 322 switches operation from the minimum electric power mode to the normal mode.

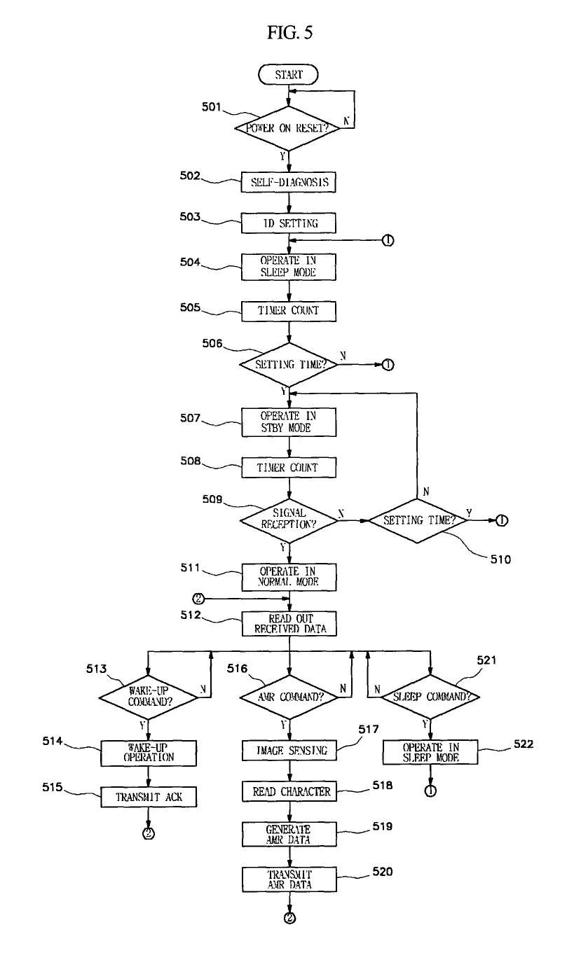

FIG. 5 is a flow chart showing operation of an MCU of an AMR terminal according to the present invention.

Referring to FIG. 5, when power is turned on, the MCU 322 performs self-diagnosis through power-on reset, checks whether or not the AMR terminal is abnormal, and then sets a terminal ID (501 to 503). The terminal ID may be previously set on an EEPROM, and preferably set by an operator on the outside using a dual inline package (DIP) switch or the like. In other words, when the terminal ID is set on a microcomputer or on a separate EEPROM, there are problems in that the AMR terminal is unsuitable for a mass production process and is inconvenient for its exchange. For this reason, when the operator installs the AMR terminal 110 using the DIP switch for the first time, it is preferred that the operator sets the terminal ID to be matched with the customer information, inputs the set resultant into the AMR server 140, and then administers the inputted resultant as the customer information.

When the self-diagnosis of the MCU and setting of the terminal ID are completed, the MCU operates in the sleep mode (504). As mentioned above, the sleep mode is designed to operate only the minimum functioning (e.g., a timer count function) of the MCU 322 in order to minimize consumption electric power. During operation in the sleep mode, the MCU 322 counts the sleep time. Then, when the sleep time reaches a predetermined setting time (e.g., 1.97 seconds in this case), an interrupt is generated. Subsequently, the MCU 322 operates in the STBY mode (505 to 507). In the STBY mode, only one function for sensing reception of the RF detection signals from the collector 120 has to be operated. There are several methods for sensing reception of the RF detection signals from the collector 120, one of which is to detect reception of the RF signals, and another of which is to demodulate the RF signals, to decode a received command, and to wake up when the decoded resultant is a wake-up command. In the embodiment of the present invention, when the RF signals are sensed primarily by the IF detector 334 of the communication module 330, the MCU 322 is designed so that it is subjected to wake-up, decodes data received through the RF IC 332 of the communication module, and operates in the normal mode when the decoded resultants are a wake-up command.

Referring again to FIG. 5, during operation in the STBY mode, the MCU 322 counts the STBY time. Then, when the STBY time does not reach a predetermined setting time (e.g., 30 milliseconds in this case) without any signal being received from the collector, the MCU 322 continues to operate in the STBY mode while counting the STBY time. Then, when the STBY time reaches a predetermined setting time (e.g., 30 ms), the MCU 322 operates in the sleep mode (507 to 510).

In the STBY mode, when the RF detection signals are received from the communication module 330, the MCU 322 operates in the normal mode (511). In the normal mode, the communication module 330 demodulates the RF signals, which are received from the collector 120, into digital data, and transmits the demodulated digital data to the MCU 322. The MCU 322 is able to read out a command by decoding the received digital data.

If the received command is a “wake-up” command, the MCU 322 is woken up. Subsequently, the AMR terminal 110 provides a preparation for AMR operation by checking an operational condition of each module. On completing the AMR preparation, the AMR terminal 110 generates an ACK signal and sends the ACK signal to the collector 120 through the communication module 330. When the ACK signal is received, the collector 120 determines that the AMR terminal 110 is ready to perform the AMR, and sends an AMR command from the AMR server 140.

The RF signals received from the collector 120 are demodulated at the communication module 330, and then are transmitted to the character recognition module 320. The MCU 322 of the character recognition module 320 decodes data received through the communication module 330. If the decoded resultant is an “AMR” command, the MCU 322 drives the image sensor 314 and receives a numeral image signal of the numeral display panel 108. The received analog image signal is converted into a digital image signal. The digital image signal is read based on a predetermined pattern recognition algorithm and is expressed into an ASCII code which it is easy to transmit. The AMR data which are expressed into the ASCII code are packetized according to a predetermined communication protocol and are transmitted to the communication module 330. The communication module 330 modulates the packetized data into RF signals and transmits the modulated signals to the collector 120. The collector 120 checks the received AMR data. If the AMR data are normal, the collector 120 transmits an ACK command or a sleep command. When the MCU 322 of the AMR terminal receives the ACK command or the sleep command through the communication module 330, the MCU 322 determines that the AMR is completed normally, and is switched to the sleep mode again (521 and 522).

Second Embodiment (The Separated Type of the Wireless Communication Mode)

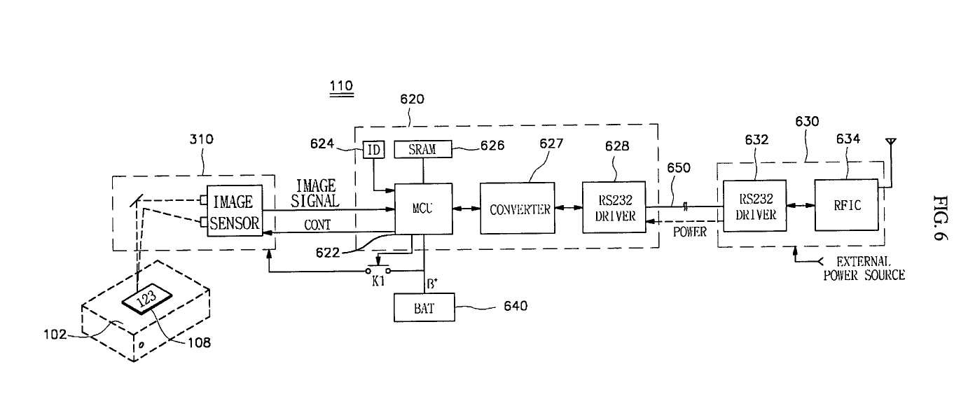

FIG. 6 shows a second embodiment of the AMR terminal of FIG. 1. The AMR terminal 110 includes a sensor module 310, a character recognition module 620, a communication module 630, and a power source 640. The AMR terminal 110 communicates with the collector 120 in the “wireless communication mode” and is the “separated type”, in which the communication module 630 is separated from the sensor module 310 and the character recognition module 620. To be more specific, in the separated type, the AMR terminal 110 is generally used when the meter is installed at a place, for instance in the ground, where wireless communication is difficult to perform. In such a case, the sensor module 310 and the character recognition module 620 are attached to the meter positioned in the ground, while the communication module 630 is separated from the body of the AMR terminal 110 and is installed on the outside of an above ground building where wireless communication is easy to perform. Here, both the sensor module 310 and the character recognition module 620 are formed into a single case, are attached to a meter 102 by a mechanical means, and make use of a battery (BAT) as a power source 640. The BAT is designed to be mounted to the AMR terminal using a BAT case and to perform its exchange with ease. In the second embodiment of the present invention, the separated type forms an interface between the character recognition module 620 and the communication module 630 in a RS232C mode, but it is possible to form the interface in other modes.

Referring to FIG. 6, the sensor module 310 is similar to that of the first embodiment, and thus an additional description will be omitted. The character recognition module 620 further includes a communication driver 628 for communicating by wire with the communication module 630 separated from the character recognition module 620, and is provided with a converter 627 for forming an interface between an MCU 622 and the communication driver 628. The communication module 630 is also provided with a communication driver 632 for communicating with the character recognition module 620 as well as an RF IC 634. The communication module 630 is separated from the body of the AMR terminal 110. Therefore, it is preferred that the communication module 630 makes use of a separate external power source. In this case, the external power source may, for example, make use of a commercial AC power source, a battery or the like. In this separated type, power of the character recognition module 620 and the sensor module 310 is preferable to be supplied through the communication module 630 rather than through the separate BAT 640.

Here, the communication module 630 performs a power saving function as has been described in FIG. 4, and supplies power to the body of the AMR terminal if necessary, but the power of the body is turned off at a normal time. To be more specific, in the case of the integrated type of FIG. 4, a separate wiring is required to supply power on the outside, so that the integrated type is designed to use the BAT 640 to a possible extent. By contrast, in the case of the separated type, a wiring 650 is needed between the body and the communication module, so that it is preferred that power is supplied from the outside to the body through a power line additionally wired.

Third Embodiment (The Wire Communication Mode)

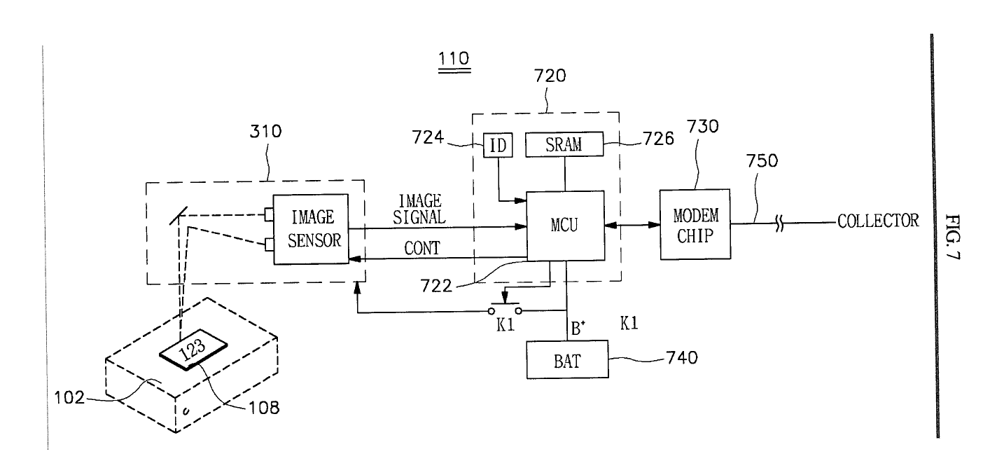

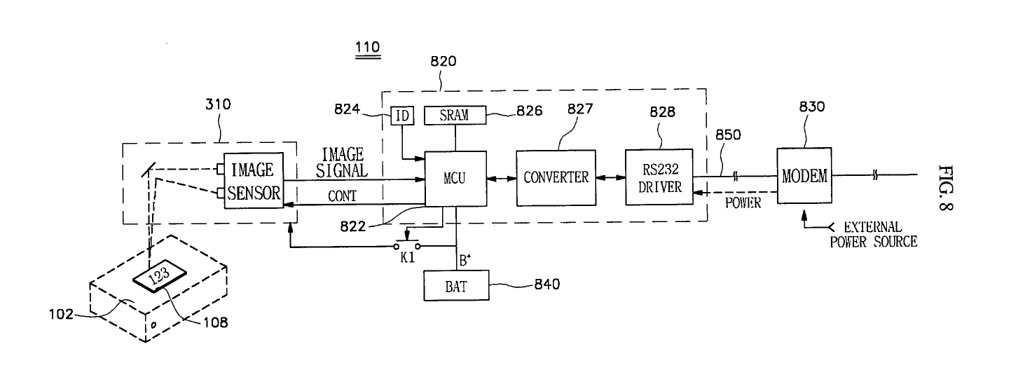

FIG. 7 is a schematic view showing a third embodiment of the AMR terminal of FIG. 1 and a situation in which a modem chip is used. FIG. 8 is a schematic view showing a situation in which an external modem is used in the third embodiment of the AMR terminal shown in FIG. 7.

Referring to FIGS. 7 and 8, the AMR terminal 110 includes a sensor module 310, a character recognition module 720 or 820, a modem 730 or 830, and a power source 740 or 840, and belongs to the case of communicating with a collector 120 in a “wire communication mode”. Here, the modem may be implemented into an internal type or an external type. In the case of the external modem, it is preferable to add a converter 827 and an RS232C driver 828 to the character recognition module 820 in order to connect with the modem 830.

Specifically, in the case of the internal modem, as shown in FIG. 7, the sensor module 310, the character recognition module 720 and the modem chip 730 are integrally constructed and attached to a meter 102 by a mechanical means. The power source may make use of a DC adaptor or the like in which a commercial power source is used, but it is preferred that the power source 340 makes use of a battery (BAT) for the sake of convenient installation. The BAT is designed to perform its exchange with ease. To this end, the BAT is mounted on the AMR terminal using a BAT case. By contrast, in the case of the external modem, the modem 830 is installed on the outside in separation from the body of the AMR terminal which includes the sensor module 310, the character recognition module 820, the RS232C driver 828 and so forth. It is preferred that the external modem 830 is adapted to make use of an external power source.

Referring again to FIGS. 7 and 8, operations of the sensor module 310 and the character module 720 or 820 are similar to those of the first embodiment. Therefore, their detailed description will be omitted in order to avoid additional repetition. Incidentally, when either an RS232C mode or an RS422 mode is used between the AMR terminal 110 and the collector 120, a driver of the RS232C mode such as MAX3223 or a driver of the RS422 mode can be added to and connected with the AMR terminal. However, the RS232C mode and RS422 mode have limitations with regards to communication distance. In reality, a modem 830 is connected between the collector 120 and the AMR terminal 110, and thus communication between them is performed through the modem 830.

In other words, when the external modem 830 is used, the RS232C driver is employed to form an interface between the modem and the body of the AMR terminal. To this end, the converter 827 and RS232C driver 828 are connected to an MCU 822.

Further, in the case of using the modem, a wake-up function of the modem may be used. To be more specific, when any signal is received, the modem chip generates a wake-up signal for performing wake-up. When this wake-up signal is transmitted to the MCU 822 of the character recognition module using a photo coupler, the MCU 822 can be constructed so that it is woken up by the wake-up signal. Meanwhile, in the case of the external modem, it is preferred that a separate power source is used to operate the external modem. In this case, it is preferred that power is supplied from the outside to the body, as in the separated type of the wireless communication mode.

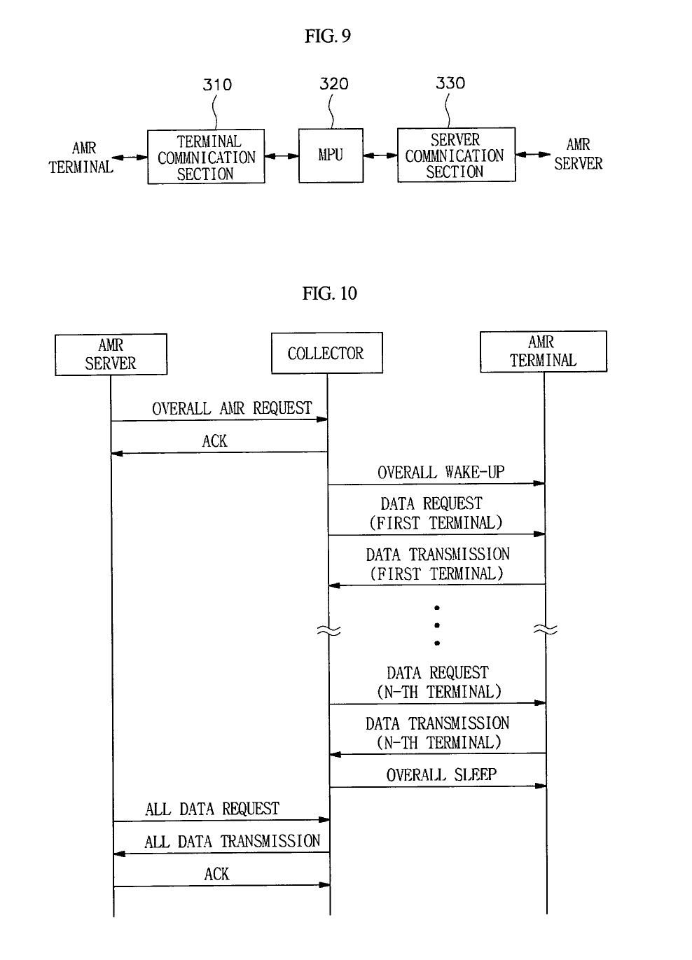

FIG. 9 is a block diagram showing construction of a collector according to the present invention. The collector of the present invention includes a terminal communication section 910, an MPU (Micro Processing Unit) 920 and a server communication section 930.

Referring to FIG. 9, the terminal communication section 910 is a portion which takes charge of a communication interface between the collector 120 and the AMR terminal 110. The terminal communication section 910 can make use of at least one of a wireless communication mode, a wire communication mode, a satellite mode and so forth according to a mode of communicating with the terminal, as will be described below.

The MPU 920 is a portion which controls the overall operations and deals with communication protocols between the server and the terminal. When the power is turned on, the MPU 920 performs a self-diagnosis and then sets a collector ID. The collector ID is set using an EEPROM or a DIP switch when the collector is installed for the first time. The MPU 920 decomposes a packet received from an AMR server 140 via the server communication section 930 and then decodes a command of the server 140. If the command is an AMR command, the MPU 920 generates a packet for designating the AMR to the corresponding AMR terminal, and then transmits the generated packet to the corresponding AMR terminal 110 via the terminal communication section 910. When the AMR terminal 110 prepares AMR data by performing the AMR, the MPU 920 transmits a data request packet to the AMR terminal 110, receives the AMR data from the AMR terminal 110 and stores the AMR data. Then, when the data request command is received through the server communication section 930, the PMU 920 transmits the AMR data to the AMR server 140 via the server communication section 930.

The server communication section 930 is a portion for performing communication between the collector 120 and the AMR server 140 through a communication network 130, and is implemented in various modes according to the communication network used.

FIG. 10 is a flow diagram showing illustrative procedures of the AMR according to the present invention.

First, the AMR according to the present invention is classified into an “overall AMR” for simultaneously performing wake-up of all the AMR terminals 110 under the control of the corresponding collector 120 to carry out the AMR, and an “individual AMR” for carrying out the AMR through a designated particular AMR terminal. These AMR commands are classified by a value of information field within a format of the packet transmitted from the AMR server 140 to the collector 120.

Referring to FIG. 10 again, the collector 120 has information on the AMR terminal 110 within an area under the control of the collector 120 and information on the collector ID. The collector ID may be set using an internal nonvolatile memory or a setting switch. This information is inputted into the AMR server 140.

The AMR server 140 transmits a packet for requesting the overall AMR to the collector 120. When the collector 120 receives an AMR command from the AMR server 140, the collector 120 decodes the received AMR command and determines the command type. Specifically, the format of the packet transmitted form the AMR server 140 to the collector 120 includes a header and a phone number, a server phone number, a collector ID, an start address (START ADD), an end address (END ADD), information, CRC (Cyclic Redundancy Check) and so forth. In the embodiments of the present invention, a header is “0xFC” in length of 1 byte, and the phone number has a length of 1 byte. Sequentially, the server phone number is represented by an ASCII code which is proportional to a length designated as the length of the phone number, and the collector ID is represented by 4 bytes. The START ADD is one of the AMR terminal which is due to perform the AMR at one time when the overall AMR command is designated, and is represented by 2 bytes. The END ADD is one of the AMR terminals which is due to perform the AMR and is represented by 2 bytes. Further, the START and END ADDs each have a 4-bit cell ID, a 2-bit Reserved and a 10-bit AMR ID. Here, the cell ID is for preventing of an interference with an adjacent cell, and the AMR ID can be set within one cell up to maximum 1024. In the case of an individual request, an individual address field is added and the START and END ADDs are fixed as “0xFFFF”.

A 1-byte information field for identifying a command is defined as in the following Table 2.

TABLE 2

| Information field | |
|---|---|
| (1 byte) | Contents |
| 0x01 | Individual AMR |
| 0xF1 | Overall AMR |
| 0x04 | Individual data |
| 0xF4 | Overall data |

As shown in Table 2, when the information field is “0x01”, it is an individual AMR command for commanding individual AMR. When the information field is “0xF1”, it is an overall AMR command for commanding overall AMR. When the information field is “0x04”, it is an individual data request command for requesting AMR data according to individual AMR. When the information field is “0xF1”, it is an overall data request command of requesting AMR data according to overall AMR.

Referring to FIG. 10 once more, the collector 120 receives a command from the AMR server 140. If the command is normal, the collector 120 transmits an “ACK”. However, if the command is abnormal, the collector 120 transmits an “NAK” for requesting retransmission.

Subsequently, the collector 120 generates and transmits a packet for sending from the collector 120 to the AMR terminal 110 in order to wake up all the AMR terminals 110 under the control of the collector 120 according to the overall AMR command. The packet transmitted from the collector 120 to the AMR terminal 110 has a format which includes a header, an AMR ID and a CRC. The header is made up of 2 bytes and is “0xACC8”. The AMR ID is made up of 2 bytes and represents the AMR terminal which is intended to undergo AMR. The information is made up of 1 byte and is defined as in the following Table 3. Finally, the CRC is made up of 2 bytes and is to check a transmission error.

TABLE 3

| Information | |
|---|---|
| (1 byte) | Function |
| 0xF0 | Wake-up and AMR request (overall AMR) |
| 0x10 | Wake-up and AMR request (individual AMR) |
| 0xDD | Data request |
| 0x04 | Sleep (individual) |
| 0x44 | Sleep (overall) |

When the information is “0xF0”, it represents a wake-up and AMR request according to overall AMR. When the information is “0x10”, this represents a wake-up and AMR request according to individual AMR. When the information is “0xDD”, this represents a data request in which the collector 120 needs the AMR terminal 110, which is subjected to wake-up, to send AMR data. When the information is “0x04”, this represents that the collector 120 receives individual AMR data normally and then causes the corresponding individual AMR terminals 110 to go to sleep. When the information is “0x44”, this represents that the collector 120 receives overall AMR data normally and then causes the corresponding overall AMR terminals 110 to go to sleep.

The collector 120 generates an overall wake-up command according to an overall AMR command and transmits the generated wake-up command to all AMR terminals 110. All the AMR terminals 110 are woken up at the same time and perform AMR to prepare AMR data.

Subsequently, the collector 120 generates and transmits a data request packet with respect to each AMR terminal 110. As a result, the corresponding AMR terminal 110 transmits AMR data to the collector 120 in a predetermined format. That is, the AMR data transmission format, which is transmitted from the AMR terminal 110 to the collector 120, includes a 2-byte header and 2-byte AMR ID, a 1-byte terminal state, a 4-byte AMR data and 1-byte information, and a 2-byte CRC. Here, a value of information field (its initial value is 0x01) is adapted to have an increment of 1 whenever a signal is transmitted to the collector 120. Further, it will be seen that the amount of data is small because the AMR data is formed into an ASCII code for numerals rather than image data.

When the collector 120 receives such AMR data, the collector 120 temporarily stores the AMR data and then repeats procedures for data request and AMR data reception with respect to a next AMR terminal 110. If the collector 120 completes collection of the AMR data with respect to all AMR terminals 110, the collector 120 transmits a sleep command for all AMR terminals 110 and converts all AMR terminals 110 into a sleep state.

Continuously, when the collector 120 receives a data request based on the overall AMR from the AMR server 140, the collector 120 transmits AMR data to the AMR server 140. A packet, which is transmitted the AMR data from the collector 120 to the AMR server 140, includes a header, a collector ID, the number of all packets, the number of present packets, AMR counts, data having a variable length, and CRC. The data also includes an AMR terminal ID, AMR data, and information. Here, the header is “0xFC” of 1 byte, and the collector ID is made up of a 4-byte collector ID. Further, all packets are made up of 1 byte and indicate the number of the total packets to be received, and the present packets are made up of 1 byte and indicate the number of packets received up to the present time. The AMR count is made up of 2 bytes and indicates a numeral of the AMR terminal. The data is repeated as many as the AMR count is, in which the AMR ID is made up of 2 bytes, the AMR data is formed into an ASCII code of 4 bytes, and the information is made up of 1 byte. When the information is “0x01”, this indicates a good state. When the information is “0xFF”, this indicates a communication error. A pattern recognition error is denoted by “A” instead of the numeral when a pattern value is expressed as an ASCII code.

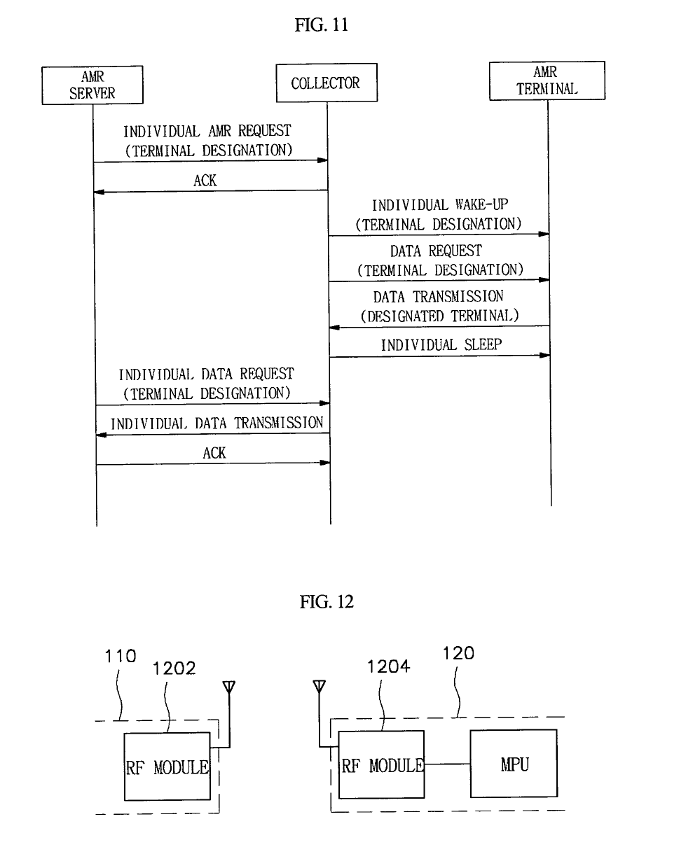

FIG. 11 is a flow diagram showing a procedure of individual AMR according to the present invention.

Referring to FIG. 11, the AMR server 140 transmits a packet requesting individual AMR to the collector 120. When the collector 120 receives a command from the AMR server 140, the collector 120 decodes the command and discriminates a command type. Here, with the packet of the individual AMR command, an information field is “0x01”, an individual address field is added, and the START and END ADDs are fixed as “0xFFFF”. The collector 120 transmits an ACK when it normally receives the command from the AMR server 140.

If the command is an individual AMR command, the collector 120 transmits an individual wake-up packet to the corresponding AMR terminal 110 in order to wake up the designated AMR terminal. The designated AMR terminal 110 is woken up according to the individual AMR command, and then performs the AMR to prepare AMR data.

Subsequently, the collector 120 generates and transmits a data request packet with respect to the corresponding AMR terminal 110. As a result, the corresponding AMR terminal 110 transmits the AMR data to the collector 120.

When the collector 120 receives these AMR data, the collector 120 checks whether or not the AMR data is normal. If the AMR data is normal, the collector 120 causes the corresponding AMR terminal 110 to go to sleep individually. When the collector 120 receives an individual data request from the AMR server 140 during a temporary storage received data, the collector 110 transmits the individual AMR data of the designated AMR terminal 110 to the AMR server 140. If the individual AMR data is received normally, the AMR server 140 transmits an ACK to the collector 120.

FIG. 12 illustrates a first interface between a collector and an AMR terminal according to the present invention. Here, the AMR terminal 110 communicates with the collector 120 by wireless. To perform wireless communication, the AMR terminal 110 is provided with an RF module 1202 and the terminal communication section 910 of the collector 120 is also implemented as an RF module 1204.

FIG. 13 illustrates a second interface between a collector and an AMR terminal according to the present invention. Here, the AMR terminal 110 communicates with the collector 120 by wire. To perform wire communication, the AMR terminal 110 is provided with an RF module 1212 and the terminal communication section 910 of the collector 120 is also implemented as an RF module 1214. Here, when the AMR terminal 110 and the collector 120 are situated more proximately, they may be directly connected to each other without a modem by using a different wire communication mode, such as RS232C, RS422 or the like. In this case, a communication driver IC, such as an RS232C driver IC or the like, may be employed.

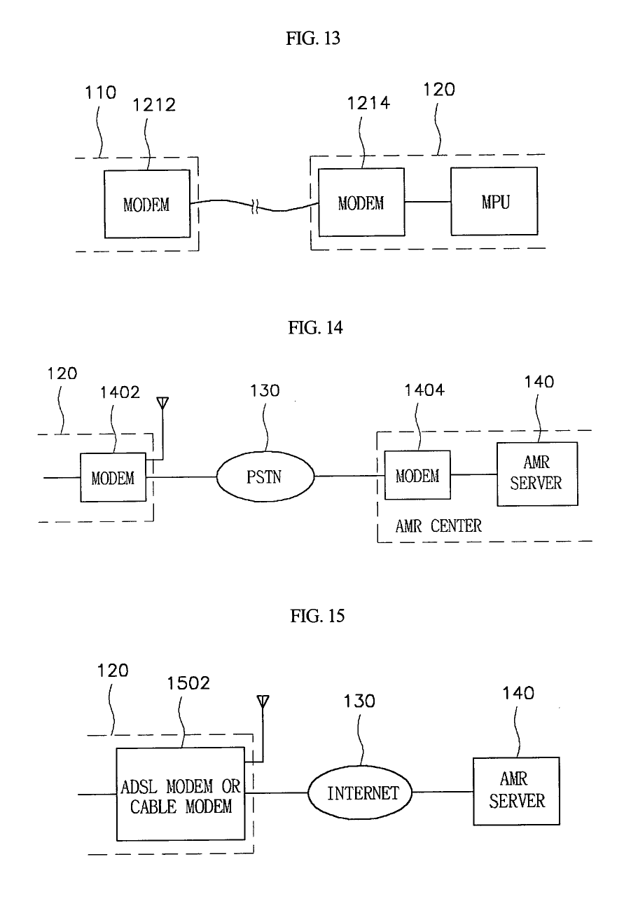

FIG. 14 illustrates a first interface between a collector 120 and an AMR server 140 according to the present invention. Here, the AMR server 140 is connected to the collector 120 using a PSTN. When the collector 120 and AMR server 140 are connected to each other using the PSTN 130, the server communication section 930 of the collector 120 is implemented as a modem 1402, and an AMR center where the AMR server 140 is situated employs the corresponding modem 1404.

FIG. 15 illustrates a second interface between a collector 120 and an AMR server 140 according to the present invention. Here, the AMR server 140 is connected to the collector 120 using the Internet 130. When the collector 120 and AMR server 140 are connected to each other using the Internet 130, the server communication section 930 of the collector 120 is implemented as an ADSL modem or cable modem 1502 for connecting to a very high speed network supporting the Internet, and is connected to the AMR server 140 through an ISP (Internet Service Provider) and network equipment, such as a router or the like.

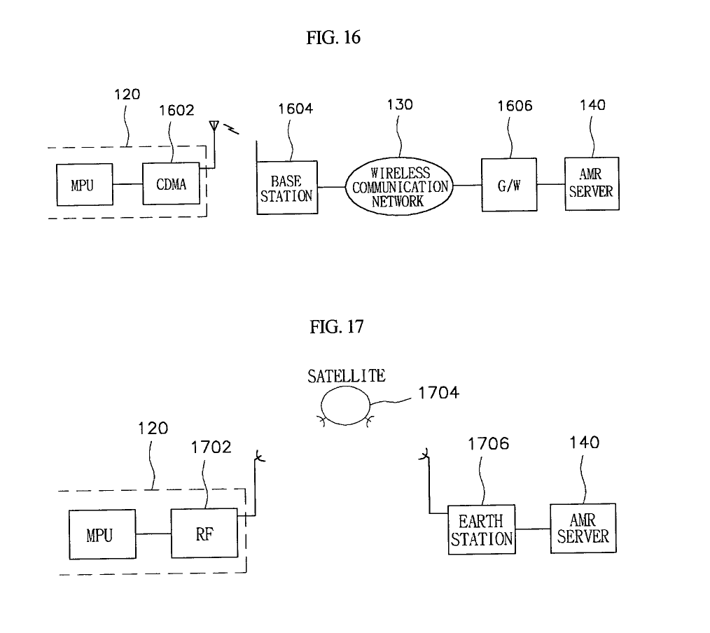

FIG. 16 illustrates a third interface between a collector 120 and an AMR server 140 according to the present invention. Here, the AMR server 140 is connected to the collector 120 through a wireless communication network 130. When the collector 120 and AMR server 140 are connected to each other through the wireless communication network 130, the server communication section 930 of the collector 120 is implemented as a CDMA chip 1602 capable of connecting to the wireless communication network, such as a mobile terminal or the like, and performs accessing through a base station 1604 of the wireless communication network. Further, a gateway (G/W) 1606 or the like is needed to form an interface between the networks. The wireless communication network 130 may be implemented as various networks, such as a public radio paging network, a PCS (Personal Communication Service) network, a cellular communication network and so forth.

FIG. 17 illustrates a fourth interface between a collector 120 and an AMR server 140 according to the present invention. Here, the AMR server 140 is connected to the collector 120 through a satellite communication network 130. When this satellite communication network 130 is used, it is suitable places such as an insular province, a mountainous backcountry or the like, where it is difficult to use a typical communication means. When the collector 120 and AMR server 140 are connected to each other using the satellite communication network 130, the server communication section 930 of the collector 120 is implemented as an RF module 1702 capable of performing satellite communication, and is capable of connecting to the AMR server 140 through a satellite 1704 and a terrestrial radio station 1706.

The present invention may be implemented using various different communication networks other than the communication networks disclosed in the foregoing embodiments.

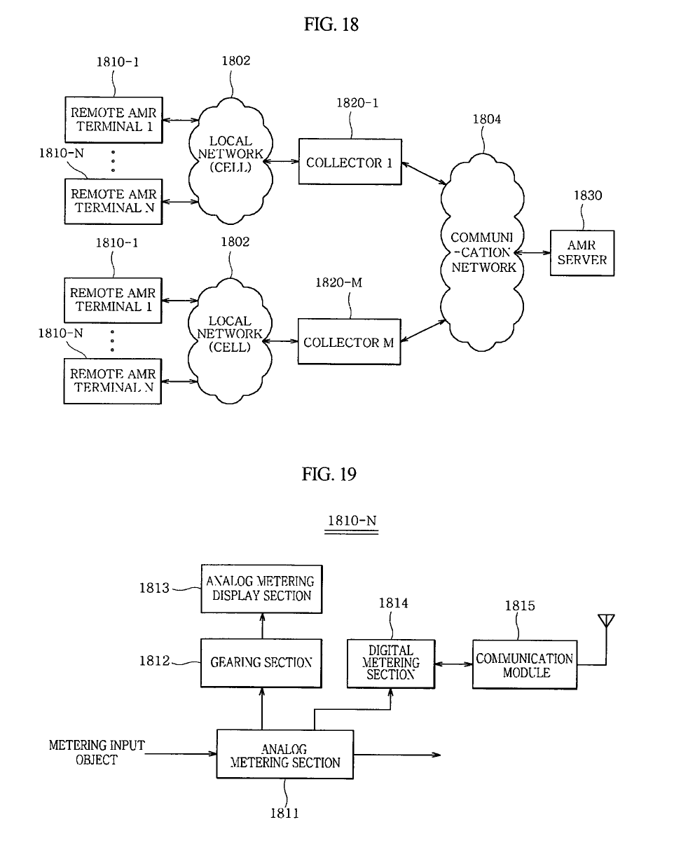

FIG. 18 shows a remote AMR system according to a second embodiment of the present invention. This embodiment makes use of a digital meter having a remote AMR function.

Referring to FIG. 18, the remote AMR system is designed so that N remote AMR terminals 1801-1 to 1810-N installed within a residential building of each customer are connected to one collector 1820-1 through a local network 1802 and M collectors 1820-1 to 1820-M are connected to the remote ARM server 1830 through a communication network 1804. The local network 1802 is a kind of communication network for connecting the collectors 1820-1 to 1820-M to the remote AMR terminals 1801-1 to 1810-N, and can be operated in a wire communication mode and/or in a wireless communication mode. In a case using wireless communication mode, an ISM (Industrial Scientific and Medical) band can be used, or various modes, such as a Blue Tooth, a wireless LAN and so forth can be used. In a case using wire communication mode, an electric power line communication mode making use of an electric power modem, an RS-232C mode, a PSTN modem mode and so forth can be used. As the communication network 1804 connecting the collectors 1820-1 to 1820-M to the remote ARM server 1830, at least one of a wireless network (mobile radio communication network, PCS network, TRS (Trunked Radio System) network, etc.), a wire network (PSTN), a satellite network, the Internet and so forth may be used.

In the second embodiment of the remote AMR system, the remote AMR terminal operates in the same manner as that of FIG. 1, except that the AMR terminal of the second embodiment continues to store its own metering values as digital data and transmits them according to a request of the AMR server. In other words, the AMR terminal of FIG. 1 is designed to add an AMR function to a typical metering section, but the AMR terminal of FIG. 18 is designed to incorporate an AMR function into the meter itself.

FIG. 19 shows a first embodiment of the AMR terminal of FIG. 18. In this embodiment, a function of an analog meter and a function of a digital meter are simultaneously implemented.

Referring to FIG. 19, an analog metering section 1811 includes a disc which rotates as an object to be metered flows, and is designed to generate a predetermined pulse whenever it rotates one turn. A gearing section 1812 is adapted to cooperate with rotation of the disc of the analog metering section and to rotate numerals of an analog metering display section 1813. This function is similar to that of a typical analog meter.

A digital metering section 1814 counts pulses which are generated during rotation of the disc of the analog metering section, and then accumulates and calculates the counted digital metering values. A communication module 1815 communicates with a collector side, and transmits digital metering data according to an AMR request of the AMR server in a wire or wireless communication mode.

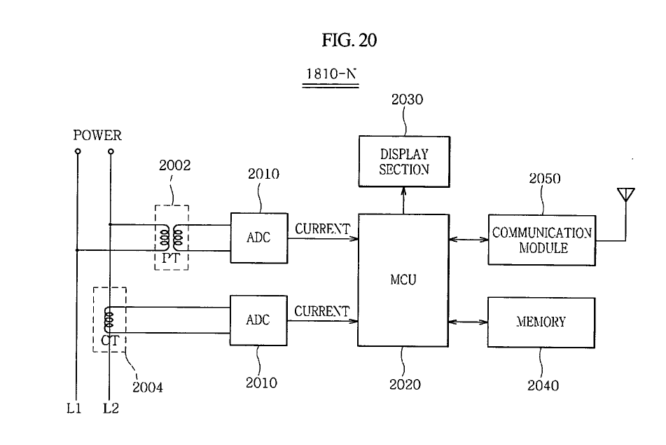

FIG. 20 shows a second embodiment of the ARM terminal of FIG. 18. In this embodiment, the ARM terminal has a function of a pure digital electric power meter.

Referring to FIG. 20, the ARM terminal 1810-N includes a power transformer (PT) 2002 for detecting a supply voltage applied to a load side, a current transformer (CT) 2004 for measuring a supply current flowing to the load side, an analog-digital converter 2010 for converting analog voltages/currents into a digital voltage/current data, a microprocessor (MCU) 2020 for receiving digital voltage/current data to calculate an amount of electric power, storing the calculated results on a memory 2040, displaying metering values on a display section 2030, and transmitting AMR data to an AMR server through a communication module 2050.

The display section 2030 is implemented as an LCD, a 7-segment display or the like, and displays metering values under the control of the MCU 2020. The communication module 2050 includes a wire or wireless communication module, and transmits AMR data to the AMR server side under the control of the MCU 2020 according to a prescribed communication protocol. The PT 2002 is designed to enable a voltage supplied to the load to be monitored to inform the AMR server of an abnormal state, such as current leakage, power failure or the like.

In the foregoing embodiments, a case in which two kinds of AMR terminals are each used is illustrated and described, but several kinds of AMR terminals can be used in combination if necessary. For instance, an AMR terminal in a digital mode can be used for electric power metering, and the AMR terminal in an image sensing mode can used for water metering.

As will be seen from the foregoing, the remote AMR system according to the present invention has several advantages in that automatic and manual meter reading of metering values can be performed by mounting an AMR terminal on an existing meter without changing the existing meter; in that maintenance costs resulting from battery exchange can be reduced by operating the battery in a power saving mode in order to minimize consumption electric power of the battery; and in that by picking up metered values into images, recognizing the images into numerals through pattern recognition, and transmitting as a code for the numerals, an amount of transmission data can be significantly decreased compared with transmission of image data themselves, and thus it is easy to perform communication. In addition, communication costs can be reduced by decreasing transmission lines or channels which are needed to perform communication using a collector.

While the present invention mentioned above has been shown and described in connection with the preferred embodiment, it is intended that the present invention is not limited to the foregoing embodiment but those skilled in the art can make various modifications and variations without departing from the principle of the invention as defined in the appended claims.

1. An automatic meter reading (AMR) system comprising:
at least one AMR terminal, attached to the corresponding meter, for transmitting meter reading data; and
an AMR server for commanding the AMR terminal to perform meter reading and for processing meter reading data transmitted from the AMR terminal to perform charging,
the AMR terminal comprising:
an image sensing module for sensing an image signal of a metering value displayed on a numeral display panel of the meter;
a character recognition module for performing pattern recognition of the image signal transmitted from the image sensing module and for generating a numeral code of the metering value to output it in a predetermined format, the character recognition module comprising a microcomputer and an ID setting means for setting a terminal ID; and
a communication module for transmitting digital data transmitted from the character recognition module to the AMR server side, wherein:
when a communication signal is received from the AMR server during operation of a power saving mode, the microcomputer wakes up and decodes received data; and
when a meter reading command is received, the microcomputer operates the image sensing module to receive the image signal of the metering value, performs pattern recognition according to a predetermined algorithm, generates the numeral code of the metering value to form a packet together with the terminal ID, and transmits the packet to the communication module.

2. An automatic meter reading (AMR) system in accordance with claim 1, wherein the microcomputer controls operation of the AMR terminal according to classified modes which include a sleep mode for minimizing consumption of electric power, a standby for sensing a wake-up signal received from the AMR server, and a normal mode for a normal operation of the AMR terminal when the wake-up signal is received from the AMR server, so that:
in a normal state, the AMR terminal operates in an operation mode periodically alternating between the sleep mode and the standby mode; and
when the wake-up signal is detected during the standby mode, the AMR terminal operates in the normal mode in order to perform the meter reading.

3. An automatic meter reading (AMR) system in accordance with claim 2, wherein the sleep mode has a duration longer than that of the standby mode, and the alternative cycle is a predetermined time.

4. An automatic meter reading (AMR) system in accordance with claim 1, wherein the communication module is a radio frequency (RF) module which modulates the digital signal transmitted from the character recognition module into an RF signal to transmit the modulated resultant to the AMR server side and demodulates the RF signal received from the AMR server side into the digital data to transmit regenerated digital data to the character recognition module.

5. An automatic meter reading (AMR) system in accordance with claim 4, wherein the RF module comprises an RF IC for modulating the digital signal into the RF signal to transmit the modulated resultant to the AMR server side, and an intermediate frequency (IF) detector for receiving an IF signal from the RF IC to detect whether or not the RF signal is present.

6. An automatic meter reading (AMR) system in accordance with claim 4, wherein the RF module is separated from a sensor module attached to the meter and the character recognition module, and is connected with the character recognition module via a communication driver by wire.

7. An automatic meter reading (AMR) system in accordance with claim 1, wherein the communication module is a modem for transmitting the digital data transmitted from the character recognition module in a wire communication mode.

8. An automatic meter reading (AMR) system in accordance with claim 1, wherein the AMR terminal further comprises a current leakage detecting means, a battery low-voltage sensing means, and a terminal separation and breakage detecting means, and the AMR terminal automatically transmits the detected resultant to the AMR server when any one of current leakage, battery low-voltage, terminal breakage, meter breakage and so forth is detected.

9. An automatic meter reading (AMR) system in accordance with claim 1, wherein the microcomputer has a function of controlling (turning on/off) the corresponding AMR terminal according to a command of the AMR server when a special situation, such as a fire, an earthquake, a typhoon or the like, occurs.

10. An automatic meter reading (AMR) system comprising:
a plurality of AMR terminals, each attached to a corresponding meter, for transmitting meter reading data;
an AMR server for commanding the AMR terminals to perform meter reading and for processing meter reading data transmitted from the AMR terminals to perform charging; and
a collector for waking up the AMR terminals under the control of the AMR server to request the meter reading data when a meter reading command is transmitted from the AMR server, and for packetizing the meter reading data collected from the AMR terminal in a predetermined format to transmit the packetized resultants to the AMR server.

11. An automatic meter reading (AMR) system in accordance with claim 10, wherein the collector comprises:
a terminal communication section for performing communication with the AMR terminals;
a server communication section for performing communication with the AMR server;
a micro processing unit (MPU) for decoding the meter reading command received from the AMR server through the server communication section to transmit a packet for waking up the corresponding AMR terminal based on the meter reading command to the corresponding AMR terminal through the server communication section, and for collecting the meter reading data from the awakened AMR terminal to transmit the collected resultants to the AMR server through the server communication section.

12. A method for transmitting meter reading data in an automatic meter reading (AMR) system comprising at least one AMR terminal attached to the corresponding meter to transmit the meter reading data, and a collector for relaying an AMR server for processing the meter reading data to perform charging, the method comprising the steps of:
transmitting a meter reading command at the AMR server;
waking up all AMR terminals under the control of the collector when the meter reading command is an overall meter reading command and requesting data with respect to each AMR terminal to collect the meter reading data;
waking up the AMR terminal designated by the collector when the meter reading command is an individual meter reading command and requesting data with respect to the designated AMR terminal to collect the meter reading data;
returning to sleep mode for the corresponding AMR terminal when collection of the meter reading data is completed; and
transmitting the collected meter reading data to the AMR server in a predetermined format when a meter reading data request command is received from the AMR server.

13. A method in accordance with claim 12, wherein a packet transmitted from the AMR server to the collector has a format which includes a header and a phone number, a server phone number, a collector ID, a start address, an end address, information and CRC (Cyclic Redundancy Check).

14. A method in accordance with claim 12, wherein:
the meter reading command includes an overall meter reading command for simultaneously waking up all AMR terminals under the control of the collector to perform meter reading, and an individual meter reading command for waking up only a designated AMR terminal to perform meter reading; and
the individual meter reading command packet has a format which includes an individual address field.

15. A method in accordance with claim 12, wherein a packet transmitted from the collector to the AMR terminal has a format which includes a header, a terminal ID, information and CRC.

16. A method in accordance with claim 12, wherein a packet transmitted from the AMR terminal to the collector has a format which includes a header, a terminal ID, a terminal state, meter reading data, information and CRC.

17. A method in accordance with claim 12, wherein:
a packet transmitted from the collector to the AMR server has a format which includes a header, a collector ID, the number of all packets, the number of present packets, AMR counts, data, and CRC; and
the data are formed through iteration of information about meter reading data and terminal IDs corresponding to a number of AMR counts.

18. An automatic meter reading (AMR) system comprising:
an AMR server for issuing a meter reading command to perform meter reading of a metering value of each customer and for collecting meter reading data to perform charging and statistical processing;
a collector for transmitting the meter reading command to a corresponding AMR terminal when the meter reading command is received from the AMR server through a communication network and for transmitting the received meter reading data to the AMR server; and
the AMR terminal including a current transformer for measuring a current applied to a load; an analog-digital converter for converting analog outputs of the current transformer into digital data; a displaying means for displaying a metering value of consumption electric power; a memory for storing at least one program and data; a communication module for providing communication function to perform the meter reading; and an operation control section for calculating amounts of present consumption electric power to perform cumulative operation using current data inputted from the analog-digital converter in each metering cycle, storing the operated resultants in the memory, and controlling to transmit the meter reading data stored in the memory through the communication module when the meter reading command is received through the communication module.

19. An automatic meter reading (AMR) system in accordance with claim 18, wherein the AMR terminal further comprises a power transformer (PT) and monitors a voltage state caused by any one of current leakage, power failure and so forth.
